(19) United States
(12) Patent Application Publication
(10) Pub. No.: US 2016/0067922 A1
(43) Pub. Date: Mar. 10, 2016

(54) THREE DIMENSIONAL (3D) PRINTING BY VOLUMETRIC ADDITION THROUGH SELECTIVE CURING OF A FLUID MATRIX

(71) Applicant: DISNEY ENTERPRISES, INC., Burbank, CA (US)

(72) Inventors: JEFFREY VORIS, PASADENA, CA (US); BENJAMIN FOSTER CHRISTEN, LOS ANGELES, CA (US); JORGE ALTED, ALTADENA, CA (US); DAVID W. CRAWFORD, LONG BEACH, CA (US)

(73) Assignee: DISNEY ENTERPRISES, INC., BURBANK, CA (US)

(21) Appl. No.: 14/480,740

(22) Filed: Sep. 9, 2014

(51) Int. Cl. B29C 67/00

(52) U.S. Cl. CPC B29C 67/0066; B29C 67/0088; B29C 67/0092; B33Y 10/00

(57) ABSTRACT

An apparatus for building a three dimensional (3D) object using volumetric addition. The apparatus includes a print chamber containing a volume of a curable resin. The apparatus includes a first and second curing energy sources outputting first and second beams of energy. The apparatus includes a controller operating targeting mechanisms to align the beams of energy to sequentially intersect at a plurality of curing positions associated with build volumes of a digital model of the 3D object. The energy sources may be lasers generating a desired amount of heat when their beams are crossed. The curable resin may be a heat-curable fluid curing when heated into a curing temperature range, and the amount of heat provided by intersected pairs of the first and second beams heats volumes of the heat-curable fluid, proximate to each of the curing positions only, to a temperature in the curing temperature range.

### BACKGROUND

1. Field of the Description

The present invention relates, in general, to fabrication of three dimensional (3D) objects, and, more particularly, to a method of 3D printing (and 3D printers configured to perform the 3D printing method) that generates 3D objects by selectively and sequentially curing portions or small volumes of a fluid matrix.

2. Relevant Background.

3D printing is a fabrication technology in which objects (or “printed 3D objects”) are created from a digital file, which may be generated from software such as a computer aided design (CAD) program or another 3D modeling program or with a 3D scanner to copy an existing object that provides input to a 3D modeling program. To prepare the digital file for printing, software that is provided on a printer-interfacing computer or running on the 3D printer itself slices or divides the 3D model into hundreds to thousands of horizontal layers. Typically, only the outer wall or “shell” is printed to be solid such that a shell thickness may be defined as part of modifying the 3D model for use in printing. Then, during printing, the shell is printed as a solid element while the interior portions of the 3D object are printed in a honeycomb or another infill design, e.g., to reduce the amount of material that has to be printed to provide the printed 3D object.

When the prepared digital file of the 3D object is uploaded into the 3D printer, the 3D printer creates or prints the object layer-by-layer. The 3D printer reads every slice (or 2D image) from the 3D model and proceeds to create the 3D object by laying down (or printing) successive layers of material until the entire object is created. Each of these layers can be seen as a thinly sliced horizontal cross section of the eventually completed or printed 3D object.

One of the more common 3D printer technologies uses fused deposition modeling (FDM) or, more generally, fused filament fabrication (FFF). FDM printers work by using a plastic filament (e.g., acrylonitrile butadiene styrene (ABS) or polylactic acid (PLA) provided as strands of filament that is 1 to 3 millimeters in diameter) that is unwound from a coil or spool mounted onto the printer housing. The plastic filament is used to supply material to a print head with an extrusion nozzle, e.g., a gear pulls the filament off the spool and into the extrusion nozzle. The extrusion nozzle is adapted to turn its flow on and off. The extrusion nozzle (or an upstream portion of the print head) is heated to melt the plastic filament as it is passed into, or through, the extrusion nozzle so that it liquefies. The pointed extrusion nozzle deposits the liquefied material in ultra fine lines (e.g., in lines that are about 01 millimeters across).

The extrusion head and its outlet are moved in both horizontal and vertical directions to complete or print each layer of the 3D model by a numerically controlled mechanism that is operated or controlled by control software running on the 3D printer (e.g., a computer-aided manufacturing (CAM) software package adapted for use with the 3D printer). The extruded melted or liquefied material quickly solidifies to form a layer (and to seal together layers of the 3D object), and the extrusion nozzle is then moved vertically prior to starting printing of the next layer. This process is repeated until all layers of the 3D object have been printed.

Presently, 3D printing is extremely slow and time consuming. For example, it may take several hours to print a single 3D object even if the 3D object is relatively small (e.g., a 3D object that is only several inches in diameter and four to twelve inches tall). The 3D printing process that uses convention 3D printers such as an FFF-based 3D printer is limited in its speed by the speed of the mechanism moving the print heads to each new position on a print layer. Hence, there remains a need for 3D printing methods and 3D printers that implement such methods that can generate a 3D object with increased speed while retaining or even improving on the quality of the 3D object.

A further problem with existing 3D printing techniques is the need for printing a support structure for any overhanging components of a 3D object. For example, a figurine of a human-like character may have its arms extending outward from its body or torso, and the aims would be cantilevered out from the body or overhand from the adjacent portions of the body. A support structure would have to be included in layers printed below or in advance of the overhanging components or portions of the 3D object to provide material upon which to print the overhanging components. This slows the printing process further as a significant amount of material may have to be printed to provide the support structure. Upon completion of printing, the 3D object requires finishing including removal of the support structure and, in some cases, sanding or polishing of the surfaces from which the support structure was removed to match the finish of adjacent surfaces. These additional steps also increase the production time of the 3D object and typically must be performed manually, which further increases fabrication costs and complexities. Hence, it would be desirable to provide a 3D printing method, and associated 3D printer, that can build up a 3D object without the need for support structures for overhanging or cantilevered components or object elements.

### SUMMARY

Briefly, a 3D printer is described that is adapted for “printing” or generating a 3D object through volumetric addition. In contrast to prior 3D printers that printed an object layer-by-layer through selected deposition from a print head, the present 3D printer acts to selectively and sequentially add volume onto the in-process 3D object from a tank of object-supply material in which the in-process 3D object is suspended or supported.

In brief, the 3D printer uses a controller that runs a slicer or builder instruction module to process the digital file defining a 3D model of an object to be printed or built by the 3D printer. The builder instruction module is software that slices or divides the 3D model into a plurality of layers or subsections that need to be sequentially built (volume by volume versus layer by layer). The 3D printer includes a printing chamber in the form of a tank containing a volume of a curable fluid or resin (also called a “fluid matrix” herein). The 3D printer further includes two or more sources of curing energy (or curing energy sources) that additively can create conditions to cure small volumes of the curable fluid or resin at targetable locations (X-Y-Z coordinates) within the tank or printing chamber.

The 3D printer also includes a targeting or aligning mechanism associated with each of the curing energy sources that are operable by the 3D printer controller running the build instruction module to aim the output of each source sequentially upon specific curing positions/targeted locations within the tank or printing chamber so as to create the curing conditions at that position/location thus causing a volume or portion of the curable fluid or resin to cure or harden. Once this volume is hardened or cured, the controller retargets or realigns each of the curing energy sources to target their outputs onto a next or new position/location in the tank or printing chamber to continue the building process and form a 3D object.

In one embodiment, the curable resin is an ultraviolet curable liquid, and the curing energy sources additively provide UV energy at the target location/curing position. In one preferred implementation, the curable resin is a heat curable resin or liquid, and the curing energy sources are two or more lasers that when their output or laser beams are targeted to intersect the targeted location or curing position an amount of heat falling within the curing temperature range of the curable resin is achieved and a volume of the resin cures or hardens so as to be added to adjacent and already built/formed portions of the 3D object. In this way, the 3D printer acts as a volumetric addition device that sequentially builds a 3D object using output streams from two or more curing energy sources that are crossed (added together) at next build (or “print”) locations (e.g., X-Y-Z coordinates) in the printing chamber or tank holding the curable resin (or “fluid matrix”).

More particularly, an apparatus (e.g., a 3D builder or printer) for building a three dimensional (3D) object using volumetric addition. The apparatus includes a print chamber adapted for containing a volume of a liquid and a volume of a curable resin or fluid matrix positioned in the print chamber. The apparatus also includes a first curing energy source outputting a first beam of energy and a second curing energy source outputting a second beam of energy. The apparatus further includes a controller operating one or more targeting mechanisms to align the first and second beams of energy to sequentially intersect at a plurality of curing positions associated with build volumes of a digital model of the 3D object.

In some embodiments, the first and second curing energy sources are lasers and the first and second beams of energy generate an amount of heat when intersected at one of the curing positions. In such embodiments, the curable resin may be a heat-curable fluid curing when heated to a temperature in a curing temperature range. The amount of heat provided by intersected pairs of the first and second beams heats a volume of the heat-curable fluid proximate to each of the curing positions to a temperature in the curing temperature range. In some useful implementations, the heat-curable fluid comprises a thermosetting plastic.

In some other embodiments, the first and second curing energy sources are ultraviolet (UV) radiation sources and the first and second beams of energy provide a UV level when intersected at one of the curing positions. In such cases, the curable resin can be a UV-curable fluid curing when exposed to a level of UV radiation in a curing range, and the energy sources can be chosen such that the UV level provided by intersected pairs of the first and second beams exposes a volume of the UV-curable fluid proximate to each of the curing positions to a level of UV radiation in the curing range. It will be understood, of course, that three or more curing energy sources may be used in the apparatus, with two being a minimum (and non-limiting) number of these sources.

In the apparatus, at least a number of the curing positions can be overhanging positions (e.g., not positioned directly over previously formed/printed material), and the digital model can be free of support structures for the number of the curing positions associated with the overhanging positions. In contrast to prior 3D printers, the build volumes associated with the number of the curing positions are supported at least in part by adjacent and uncured portions of the curable resin in the print chamber.

In some implementations, the controller includes a processor running a build instruction module, and the build instruction module generates the digital model of the 3D object including X-Y-Z coordinates for the build volumes in the print chamber by processing a digital filed defining 3D object model to divide the 3D object model into the build volumes. The build instruction module defines orientations of the first and second curing energy sources to target each of the curing positions.

### BRIEF DESCRIPTION OF THE DRAWINGS

FIG. 1 is a functional block diagram of a 3D build or print system during printing or building operations to create a 3D object through volumetric addition;

FIG. 2 is a flow diagram for a method of fabricating or printing a 3D object using a volumetric addition-based 3D printer or builder such as with use of the system of FIG. 1; and

FIGS. 3 and 4 illustrate perspective side views of one embodiment of a 3D builder or printer during its operations to create a 3D object via volumetric addition.

### DETAILED DESCRIPTION

The inventors recognized that existing or conventional 3D printers, such as FFF-based 3D printers, are extremely slow in printing a 3D object. Further, conventional 3D printers require that support structure must be printed for any overhanging portions of the 3D object, which further slows the printing process and requires post-printing fabrication steps to remove the support structure. To address these and other issues with conventional 3D printers, a 3D printer (or builder system) is taught herein that, instead of building up an object by creating successive layers, builds or forms a 3D object by sequentially solidifying small volumes or portions of a fluid matrix.

The 3D printer or builder system includes a “printing chamber” in the form of a tank containing a volume of fluid, which has specific properties that causes it to harden under appropriate conditions (e.g., a curable resin or fluid that hardens or cures when exposed to curing conditions). One example of such a curable resin or fluid is a thermosetting plastic (or heat-curable resin/liquid) that hardens when it is heated to a temperature within a curing temperature range. In another example, the curable resin/fluid may take the form of a UV-curing resin.

The 3D printer or builder system further includes a two or more curing energy sources that are selectively targeted or aimed into the curable resin/fluid in the tank to cross or have their beam paths intercept each other at a curing position or target location. The energy of these sources is additive to generate a curing condition for the particular curable resin/fluid, and targeting mechanisms or drivers are operated by a controller running software (e.g., a builder instruction module or the like) that processes a 3D model defined in a digital file input into the controller to determine sequential build volumes or portions to be formed to build up the 3D model via volumetric addition of hardened/cured material.

In the example of a heat-curable resin/liquid, the curing energy sources may be lasers that are aimed by the controller into the fluid in the tank/print chamber so that their output beams intersect or cross at the point (or X-Y-Z coordinates of a curing position or target location) where the builder instruction module determine it is desirable to next harden the material to form the 3D object. The appropriate conditions to cure or harden the fluid (e.g., a temperature within a curing temperature range for a thermosetting plastic) are created at this intersection point and, for the most part, only at this intersection point (e.g., not in portions of the liquid where only a single beam travels).

The lasers or other curing energy sources would harden material at a significantly faster rate than traditional 3D printers. Further, since the 3D object is being built up at a depth within the curable resin or the fluid matrix, no support structures would generally be required as the surrounding but yet uncured curable resin would act to support the portions of the 3D object as they are built or “printed.” Once a 3D object is fully built or created, it may simply be lifted from the fluid in the print chamber or tank, without the need for prying it off of a build plate or for removing unwanted support structure. The print chamber or tank may then be refilled with additional curable resin to replace that used to form the 3D object, and a new model may then be created or printed with the 3D printer or build system.

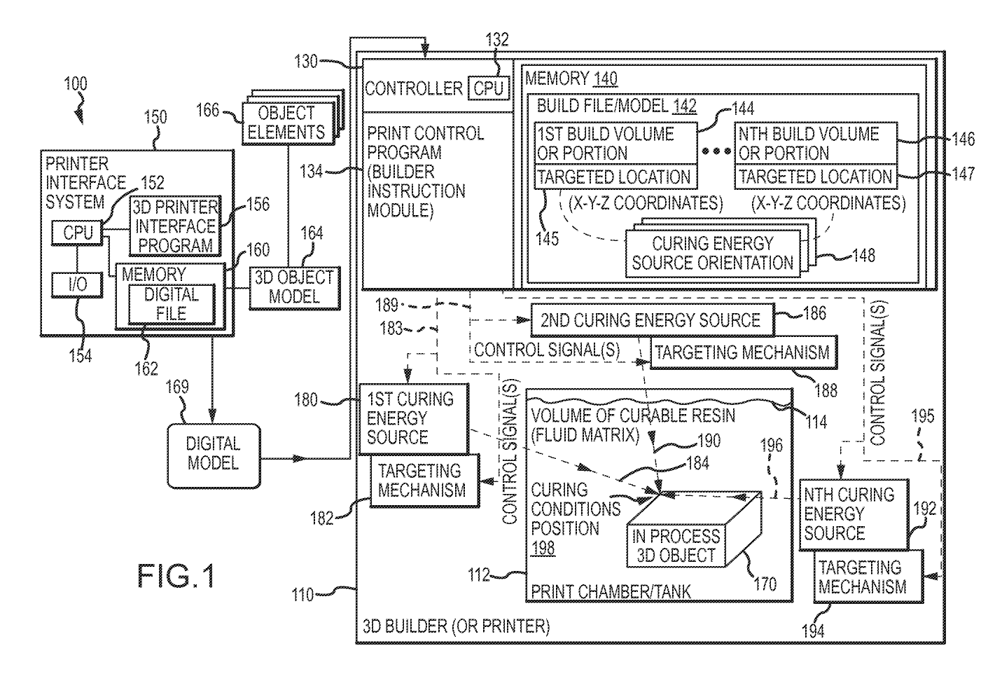

FIG. 1 is a functional block diagram of a 3D build or print system 100 during printing or building operations to create a 3D object 170 through volumetric addition. As shown, the system 100 includes a 3D printer (or build device) 110 and a printer interface system 150. The printer interface system 150 may be a desktop computer, a workstation, a laptop or pad computer, or other computer device operable by a user of the 3D printer 110 to select and transmit a digital model 169 to the 3D printer 110 for use in printing the 3D object 170. To this end, the printer interface system 150 includes a processor or central processing unit (CPU) 152 that operates or manages input and output (I/O) devices 154 such as a monitor, a touchscreen, a mouse, a keyboard, speakers, voice recognition devices, and the like that allow an operator or user of the system 150 to provide user input.

Particularly, the printer interface system 150 may include memory devices or data storage components (e.g., non-transitory computer readable medium) 160 (or have access to such memory devices) that are managed by the processor 152 to store one or more digital files 162 that are used to print a 3D object 170. Also, the system 150 may use the CPU 152 to execute code or software (in computer readable medium such as RAM, ROM, or the like on the system 150) in the form of a 3D printer interface program 156. The interface program 156 may be downloaded onto the system 150 to allow an operator to interact with the 3D printer 110 and its print controller 130, and the 3D printer 110 may provide this software/program 156 upon a first link of the system 150 and the 3D printer 110 or the software/program 156 may be downloaded separately (e.g., by inserting a CD, memory stick, or the like into the system 150, by accessing a web site associated with the 3D printer 110, or the like).

In practice, the 3D printer interface program 156 may be adapted to cause a series of interface screens to be presented by the system 150 and the I/O devices 154 to a user. The user may select a 3D object for printing by first generating a 3D model 164 of a 3D object made up of a number of object elements 166, and this definition may also include setting a thickness for an outer shell of object 170 and a structural infill (e.g., one or more honeycomb patterns). Then, during operations, the printer interface system 150 is operable to communicate (wirelessly or in a wired manner) with the 3D printer 110 including transmitting a digital model 169 (or sending the digital file 162 with a definition of the 3D object) to the 3D printer 110 for use by the print control program or builder instruction module 134 to print a multi-color 3D object 170 (in other cases, the print control program 134 accesses the digital file 162 in the memory 160, as needed for printing, rather than transmitting the model 169 to the 3D printer).

The 3D printer or builder 110 includes a tank 112 that is adapted for holding a volume of a liquid, and it may have sidewalls that are glass, ceramic, metallic, plastic, or the other material sealed together to be leak tight or leak resistant (although it may be desirable to have translucent to transparent sidewalls since it may be an engineering challenge to have opaque walls since the curing energy has to have a path to enter the fluid matrix). The tank 112 may have a cross sectional shape that is rectangular, circular, or another desired shape, and the volume of the tank 112 may range widely to practice the system 100 such as several ounces up to 16 to 32 ounces or more depending on the size of the 3D object 170 to be built or created with the 3D builder 110. To prepare for building or printing, the tank or print chamber 112 is filled with a desired volume of a curable resin or a fluid matrix 114. For example, the curable resin may be a heat-curable fluid such as a thermosetting plastic that hardens into a solid or cures when heated to a temperature falling within a curing temperature range (or greater than a minimum curing temperature which may be thought of as the low end of a curing temperature range). In other cases, the curable resin or fluid is a UV-curable fluid that hardens or cures when the UV energy applied to it is within a UV energy range (e.g., over a minimum UV energy level). In any of these cases, the curable fluid or resin 114 may be thought of as object-supply material or a print material supply that takes the place of conventional filaments in supply spools of a conventional 3D printer.

The 3D builder or printer 110 includes a controller 130 for interfacing with the printer interface system 150 so as to print or create a 3D object 170 based on the digital file 162 and its defined digital model 160. The controller 130 includes a processor 132 executing or running software/code in the form of a print control program or builder instruction module 134 (e.g., code in non-transitory, computer readable media accessible by the CPU 132 such as memory 140). The builder instruction module 134 processes the digital model 169 of the 3D object 164 and its object elements 166 to define a build file or model that determines or defines how to control a number of curing energy sources 180, 186, and 192 (three shown but there may be two or more curing energy sources may be used in some embodiments) to create or print the digital model 169 in the curable resin 114 of the print chamber/tank 112.

Particularly, a first build volume or portion 144 is defined that will be the first portion of the 3D object 170 created and then each additional build volume or portion up to the last or Nth build portion 146 that will provided in the 3D object 170. Instead of layer by layer, the builder instruction module 134 divides the digital model 169 into a plurality of volumes that will be sequentially added to provide the 3D object 170. For each build volume or portion 144 of the digital model 169, the build file or model 142 includes a targeted location or curing position (e.g., X-Y-Z coordinates within the interior volume of the print chamber or tank 112). Further, the builder instruction module 134 may calculate an orientation or targeting/alignment configuration of each curing energy source as shown at 148 in memory 140, with the set of these orientations being selected such that the outputs or output beams (e.g., laser beams, UV rays, or the like) of the two or more curing energy sources 180, 186, 192 cross or intersect at the targeted location 145, 147 of the build volumes 144, 146. It is likely that the curing time will be very short (e.g., a small percentage of a second), but it will be understood that the curing energy source orientations or targeting configurations will be held for a cure time at to cross their beams at each targeted location for a time falling within a cure time for the curable resin 114 in the print chamber/tank 112 before being moved onto the next targeted location 145, 147.

During operations of the 3D builder 110, the print control program 134 or another program of the controller 130 may act to sequentially transmit control signals 183, 189, 195 to each of the curing energy sources 180, 186, 192 to output energy rays or beams 184, 190, 196. Concurrently or immediately prior, control signals 183, 189, 195 are transmitted by the controller 130 (or its software) to targeting or alignment mechanisms 182, 188, 194 associated with the curing energy sources 180, 186, 192.

The targeting or alignment mechanisms 182, 188, 194 (e.g., electric motor-driven actuators or the like) function to orient or position the sources 180, 186, 192 or their outlet lenses to cause the output beams or rays 184, 190, 196 to be directed into the curable resin 114 and to intersect or cross at the present targeted location or curing position 198 (e.g., a next one of the targeted locations 145, 147 associated with one of the build volumes or portions 144, 146 that define volumetric additions being used to create the in-process 3D object 170).

At the intersection or targeted location 198 (may be a point or a small volume about such a targeted location 198), the curing conditions are created for the curable resin 114. When the curable resin 114 is a UV-curable fluid, the curing energy sources 180, 186, 192 may be UV light sources that provide UV light or rays 184, 190, 196 that when combined or crossed at point 198 provide UV levels within a curing range (or above a minimum UV level) that causes the resin 114 to cure or harden at the location 198 to create a next added portion or volume of the in-process 3D object. When the curable resin 114 is a heat-curable fluid such as a thermosetting plastic fluid, the curing energy sources 180, 186, 192 may be lasers that provide laser beams 184, 190, 196 that when crossed or intersected at targeted location 198 generate heat that causes the temperature of the resin 114 at the location 198 or within a small volume about the location 198 to rise into a curing temperature range (or above a minimum cure temperature) for the curable resin 114. It is believed by the inventors that the curing of volumes of the resin and then movement of the energy sources 180, 186, 192 (or their outlets) to a next targeted location in the tank 112 can be performed at a much quicker speed or build rate than conventional 3D printers, which will allow a similarly sized and shaped model to be printed much more quickly using the 3D builder 110 of the system 100 (e.g., an increase in speed of 2 to 10 times or more).

As each volume of the resin 114 is cured or hardened, it bonds or mates with a previously formed volume or portion of the resin 114 to create, build, or “print” the 3D object. In this way, the 3D builder or printer 110 creates the object using volumetric addition (e.g., volume-by-volume). The surrounding resin acts to support the in-process 3D object 170 (e.g., the object 170 does not rise or sink in the tank 112 since both the object 170 and the resin/fluid 114 have the same or substantially the same specific gravity). Hence, there is no need for a support structure to be built or provided for overhanging object elements 166 that are recreated in the printed 3D object 170 by operating the 3D builder 110.

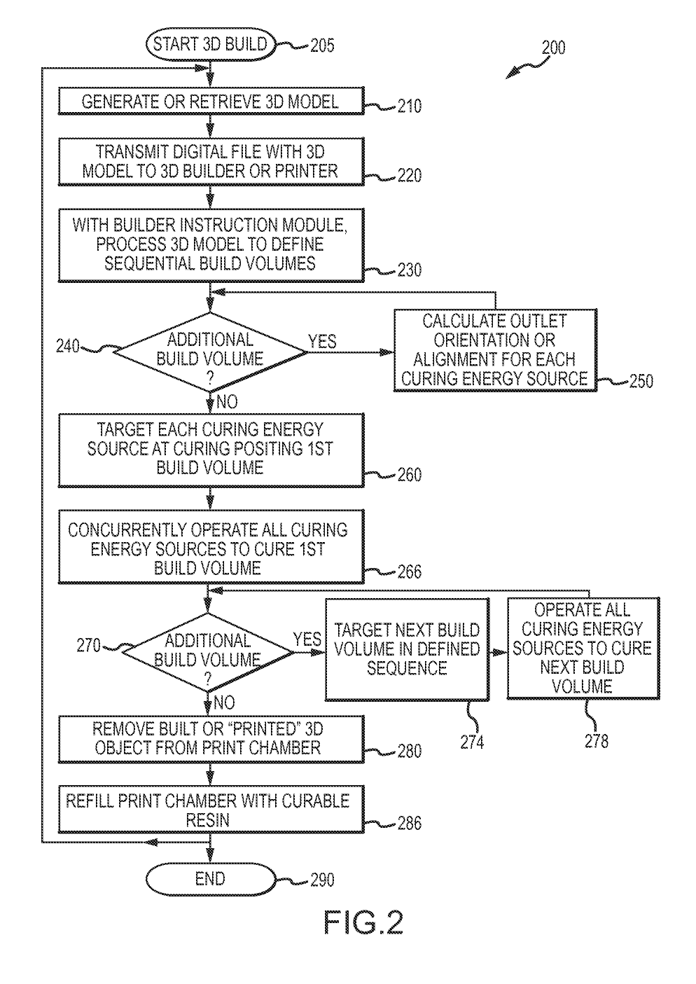

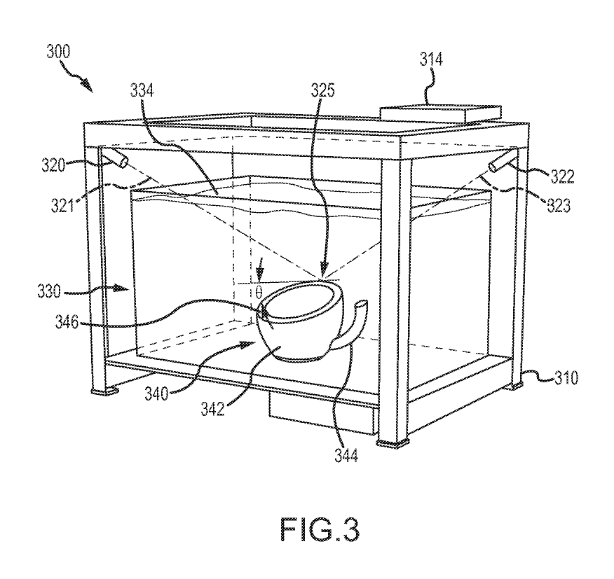

FIG. 2 illustrates a 3D building or printing method 200 that may be performed according to the present description such as by operation of the system 100 of FIG. 1 or the 3D builder or printer shown in FIG. 3. The method 200 starts at 205 such as with filling a print chamber or tank with a volume of curable fluid or resin (e.g., a UV or heat-curable fluid such as a thermosetting plastic). Step 204 may also include communicatively linking a printer interface system/computer with a 3D printer or builder and further include providing 3D printer-to-user device interface software on a user's printer interface system/computer.

The method 200 continues at 210 with generating a 3D model of an object or retrieving/selecting a previously generated 3D model. The method 200 continues at 220 with transmitting the digital file with the 3D model to a 3D printer or its controller that is configured for additive volume-based printing as taught herein (or the controller of the 3D builder or printer may access a memory device storing the digital file as needed in step 220 and during printing/building processes).

In step 230, the method 200 continues with the 3D printer control software (e.g., builder instruction module) functioning to process the 3D model of the object. This processing includes defining a plurality (e.g., thousands of) print or build volumes/portions of the 3D model of the object (e.g., divide the 3D model into numerous small parts or volumes) for use in building or printing a 3D object. These build or additive volumes are selected to have a size corresponding to a volume that can be cured using a set of curing energy sources with a particular curable resin, and the build volumes typically are adjacent to each other so as to build up volume-by-volume a 3D object, but these do not all have to be in the same horizontal layer as was the case with conventional 3D printing. Typically, an X-Y-Z coordinate in the print chamber is defined for and/or associated with each build volume, and these coordinates indicate where output beams or rays of the curing energy sources should cross or intersect to create curing conditions in the curable resin contained within the print chamber or tank to cure the particular build volume or portion.

The method 200 continues at 240 with determining (e.g., with the printing control software running on the 3D printer or builder) whether there are additional layers to be processed, and, if so, the method 200 continues at 250 with calculating or determining an outlet orientation or direction/alignment for each curing energy source to achieve intersection or crossing at the X-Y-Z or targeted location (or curing position) of the build volume.

If all build volumes have been processed to generate/calculate targeting or orientation data, the method 200 may continue at 260 with targeting each of the curing energy sources in the 3D builder to intersect their beams or outputs at or near the curing position of the first build volume or portion of the build/print file for the present 3D model. For example, the energy sources may be UV light sources or lasers, and the UV rays or laser beams may be directed to intersect at the X-Y-Z coordinates determined in step 230. To this end, the print controller may transmit control signals to targeting or alignment mechanisms of each curing energy source to cause the source or its outlet devices (lenses or the like) to aim the outputs toward the curing position in the print chamber associated with the first build volume. At step 266, the print controller may control the curing print sources to concurrently operate to generate outputs (e.g., rays or beams of energy) with the alignment or orientation set at step 260. As a result of the crossing of the outputs of these energy sources, curing conditions are created in a small volume of curable resin surrounding or proximate to the intersection point (e.g., the curing position or targeted location in the print chamber), and this small volume of curable resin is cured or hardened so as to be added to the 3D object (here, the first volume or portion of material is added to the in-process 3D object).

With the first build volume created (and supported by the remaining uncured fluid matrix in the print chamber), the method 200 continues at 270 with determining whether there are addition portions of the 3D object to build or print. If yes, the method 200 continues at 274 with targeting the curable energy sources onto a next build volume in the build sequence defined in step 230, and then at 278 each of the energy curing sources are operated to generate their outputs (beams or rays or the like). The two or more outputs of these energy sources cross or intersect at a point (e.g., a next curing position) that is adjacent or proximate to the prior curing position so as to create a curing condition in the curable resin that causes an additional volume of the curable resin to cure/harden and mate with the preceding build volume. The method 200 then continues at 270.

Once there are no further build volumes at 270, the method 200 continues at 280 with removing the build or printed 3D object from the print chamber. The 3D object may be further processed such as with applying paint or a coating, but there is no need to remove a support structure would be the case with many 3D objects printed with a conventional 3D printer. The method 200 continues at 286 with refilling the print chamber with a volume of the curable resin to replace the volume used to build the 3D object removed in step 280. The method 200 may continue at 210 or may then end at 290.

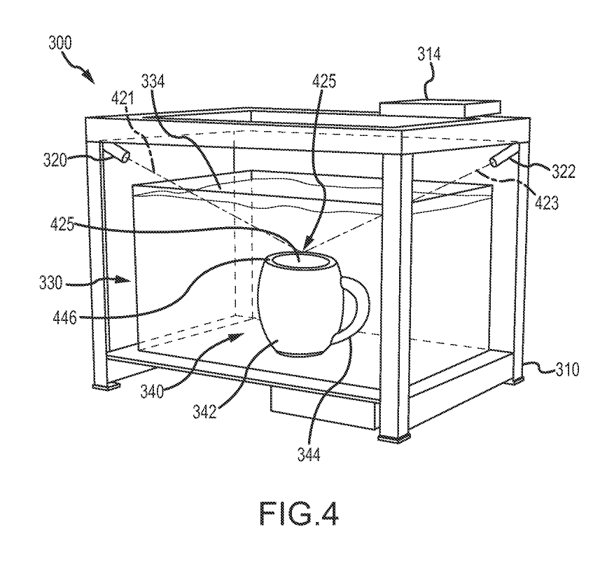

FIGS. 3 and 4 illustrate one embodiment of a 3D builder or printer 300 that may be used in the system 100 of FIG. 1 and that is especially configured to create or “print” 3D objects using volumetric addition. FIG. 3 illustrates the 3D builder 300 in at first step or phase of building or printing a 3D object 340 (i.e., a cup with a body 342 and a handle 344 that extends out from or overhangs from the body 342) while FIG. 4 illustrates the 3D builder in a later or second step/phase of building the 3D object 340 (e.g., at or near a final addition of a volume of print or supply material). The 3D builder 300 includes a housing or support frame 310 including vertical legs used to support a base and a top upon which a printer controller 314 is mounted and that may configured as shown for controller 130 of FIG. 1 with hardware and software for controlling operations of the 3D builder 300 including providing control signals to position curing energy sources (shown for 3D builder 300 to include two lasers 320, 322) target their outputs into a curable resin.

On the base of the housing or support frame 310, a print chamber or fluid tank 330 is positioned that may have clear sidewalls to allow building or printing to be observed, and the sidewalls are sealed or adapted to be leak resistant when the tank 330 is filled with a liquid or fluid. Particularly, the tank 330 is rectangular in shape in this embodiment and adapted to contain a volume of a fluid matrix or curable resin 334. In this embodiment of 3D builder 300, the curable resin or fluid matrix 334 is a heat-curable resin or fluid such as a thermosetting plastic or the like.

The 3D builder 300 further includes two lasers 320, 322 (but three or more may be used) to provide curing energy sources, and a targeting mechanism (not shown) would be included in the 3D builder for each of the lasers 320, 322 (or a system may be provided for positioning all energy sources). The controller 314, as discussed with reference to FIGS. 1 and 2, is operable to sequentially position and operate each of the energy sources 320, 322 to build the 3D object 340 by adding volume after volume of cured/hardened portions of the curable resin 334.

Particularly, the 3D object 340 is shown to be a cup with a body 342 and a handle (overhanging object element) 344. The 3D builder 300, as shown in FIG. 3, through numerous curing steps to cure/harden a plurality of build volumes to print or create the body 342 and the handle 344. In the build phase or step shown in FIG. 3, the lasers 320, 322 have been positioned by the controller such that their output beams 321, 323 are directed into the volume of curable resin 334 in the print chamber or fluid tank 330. The beams 321, 323 cross or intersect at the curing position or targeted location 325, which is on an upper, exposed surface 346 of the cup's body 342.

As a result, a volume of the curable resin 334 adjacent or surrounding (e.g., a sphere with a relatively small diameter) is placed into a curing condition by heating to a temperature in a curing temperature range (or above a minimum cure temperature). This small volume of the resin 334 hardens or cures and is affixed to adjacent or abutting portions of the surface 346 on the body 342 of the cup 340 (or 3D object). Interestingly, the build or print surface 346 of the object 340 is not horizontal during the phase or step shown in FIG. 3, but the surface 346 is instead at an offset angle, θ, below a horizontal plane of about 30 degrees.

Building or printing by volumetric addition can, thus, be seen to differ from conventional 3D printing in which horizontal layers are printed sequentially whereas volumetric addition-base printing may build vertically in one area and then move to another portion or object element of the 3D object 340. Also, it can be seen in FIG. 3 that the overhanging object element or cup handle 344 can be printed or build up without the use of a support structure as the handle 344 is built laterally as well as vertically from the sides of the body 342 while also being supported by the curable resin or fluid matrix 334 (e.g., cantilever forces not wholly supported by nearby portions of the body 342 or arm 344 but instead by resin 334 below the built volume).

FIG. 4 illustrates the 3D builder 300 at a later or second phase or step of building the 3D object 300. At this point in the operations of builder 300, numerous additional build volumes have been created and “printed” onto the body 342 and handle 344 (e.g., with the handle 344 being completely built or formed by curing additive volumes of resin 334). As shown, the lasers 320, 322 have been repositioned by the controller 314 through operations of targeting or alignment mechanisms (not shown) from their positions shown in FIG. 3. As shown, the outputs or beams 421 and 423 are aligned or aimed into the print chamber 330 so as to cross or intersect at a second or new curing position or targeted location 425 in the curable resin 334. This creates heat or provides curing conditions for the heat-curable resin 334, as a volume of the resin 334 about the position/location 425 has its temperature raised to a temperature within a temperature curing range for the resin 334 (e.g., a thermosetting plastic with a predefined curing temperature range). At this near completion phase or step, the build surface 446 of the body 342 is now nearly horizontal, and the cured volume of the resin 334 near position/location 425 is added to (e.g., mates and bonds with) neighboring or abutting portions of the body 342 and/or build surface 446 (e.g. previously printed or formed portions of the 3D object 340).

Although the invention has been described and illustrated with a certain degree of particularity, it is understood that the present disclosure has been made only by way of example, and that numerous changes in the combination and arrangement of parts can be resorted to by those skilled in the art without departing from the spirit and scope of the invention, as hereinafter claimed.

We claim:

1. An apparatus for building a three dimensional (3D) object using volumetric addition, comprising:
a print chamber adapted for containing a volume of a liquid;
a curable resin positioned in the print chamber;
a first curing energy source outputting a first beam of energy;
a second curing energy source outputting a second beam of energy; and
a controller operating one or more targeting mechanisms to align the first and second beams of energy to sequentially intersect at a plurality of curing positions associated with build volumes of a digital model of the 3D object.

2. The apparatus of claim 1, wherein the first and second curing energy sources are lasers and the first and second beams of energy generate an amount of heat when intersected at one of the curing positions.

3. The apparatus of claim 2, wherein the curable resin comprises a heat-curable fluid curing when heated to a temperature in a curing temperature range and wherein the amount of heat provided by intersected pairs of the first and second beams heats a volume of the heat-curable fluid proximate to each of the curing positions to a temperature in the curing temperature range.

4. The apparatus of claim 3, wherein the heat-curable fluid comprises a thermosetting plastic.

5. The apparatus of claim 1, wherein the first and second curing energy sources are ultraviolet (UV) radiation sources and the first and second beams of energy provide a UV level when intersected at one of the curing positions.

6. The apparatus of claim 5, wherein the curable resin comprises a UV-curable fluid curing when exposed to a level of UV radiation in a curing range and wherein the UV level provided by intersected pairs of the first and second beams exposes a volume of the UV-curable fluid proximate to each of the curing positions to a level of UV radiation in the curing range.

7. The apparatus of claim 1, wherein at least a number of the curing positions are overhanging positions and wherein the digital model is free of support structures for the number of the curing positions associated with the overhanging positions, whereby the build volumes associated with the number of the curing positions are supported at least in part by adjacent and uncured portions of the curable resin in the print chamber.

8. The apparatus of claim 1, wherein the controller comprises a processor running a build instruction module, wherein the build instruction module generates the digital model of the 3D object including X-Y-Z coordinates for the build volumes in the print chamber by processing a digital filed defining 3D object model to divide the 3D object model into the build volumes, and wherein the build instruction module defines orientations of the first and second curing energy sources to target each of the curing positions.

9. A 3D printer, comprising:
a tank containing a volume of a curable fluid;
two or more curing energy sources each with a targeting mechanism for aiming output of the energy sources into the tank; and
a print controller sequentially operating the targeting mechanisms to direct two or more of the outputs to cross at targeted locations within the tank, wherein curing conditions are sequentially generated for a plurality of volumes of the curable fluid in the tank and wherein the plurality of volumes are sequentially hardened in the tank to build up a 3D object.

10. The 3D printer of claim 9, wherein the curable fluid comprises a heat-curable resin and wherein the curing conditions comprise a temperature of the volumes of the curable fluid in a curing temperature range of the heat-curable resin.

11. The 3D printer of claim 10, wherein the two or more curing energy sources each comprises a laser.

12. The 3D printer of claim 10, wherein the heat-curable resin comprises a thermosetting plastic.

13. The 3D printer of claim 9, wherein, the curable fluid comprises a UV-curable resin and wherein the curing conditions comprise a range of UV levels and wherein the two or more curing energy sources each comprises a UV radiation source.

14. The 3D printer of claim 9, wherein the targeted locations are each associated with a volume of build volume for a digital model of the 3D object.

15. A method for forming a 3D object, comprising:
first targeting a beam of energy from a first curing energy source into a tank of a curable fluid;
second targeting a beam of energy from a second curing energy source into the tank, wherein the beams of energy cross to create curing conditions for the curable fluid proximate to an intersection point of the beams of energy;
maintaining orientations of the beams of energy for a curing period to cure a volume of the curable fluid proximate to the intersection point; and
repeating the first targeting, the second targeting, and the maintaining steps for a plurality of successive intersection points of the beams of energy in the curable fluid in the tank, wherein each of the intersection points is associated with a build volume of a digitally modeled 3D object.

16. The method of claim 15, wherein the curable fluid comprises a heat-curable resin.

17. The method of claim 16, wherein the first and second curing energy sources each comprises a laser.

18. The method of claim 15, wherein the curable fluid comprises a UV-curable resin and wherein the first and second curing energy sources each comprises a source of UV radiation.

19. The method of claim 15, wherein the intersection points are each defined by a differing set of X-Y-Z coordinates.

20. The method of claim 19, further comprising generating a build model by dividing the digitally modeled 3D object into the build volumes, wherein at least a number of the build volumes overhang from neighboring portions of the digitally modeled 3D object.
